(19) United States
(12) Patent Application Publication
(10) Pub. No.: US 2013/0246642 A1
(43) Pub. Date: Sep. 19, 2013

(54) METHOD AND APPARATUS FOR ESTABLISHING AUDIO AND VIDEO COMMUNICATION CONNECTION

(71) Applicant: TENCENT TECHNOLOGY (SHENZHEN) COMPANY LIMITED, (US)

(72) Inventor: Qian Chen, Guangdong (CN)

(73) Assignee: TENCENT TECHNOLOGY (SHENZHEN) COMPANY LIMITED, Guangdong (CN)

(21) Appl. No.: 13/875,622

(22) Filed: May 2, 2013

Related U.S. Application Data
(63) Continuation of application No. PCT/CN2012/070304, filed on Jan. 13, 2012.

(30) Foreign Application Priority Data
Feb. 28, 2011 (CN) 201110047721.4

(51) Int. Cl. H04L 29/08

(52) U.S. Cl. CPC H04L 67/14
USPC 709/228

(57) ABSTRACT

A method and apparatus for establishing an audio and video communication connection is provided. The method comprises the steps of establishing server-relayed connections with a plurality of clients; attempting to establish direct or client-relayed connections with the plurality of clients; and if the attempt to establish direct or client-relayed connections with the plurality of clients is successfully, disconnecting the server-relayed connections with the plurality of clients. The apparatus comprises a first building module for establishing server-relayed connections with a plurality of clients, a second building module for attempting to establish direct or client-relayed connections with the plurality of clients; wherein the first building module is configured to disconnect the server-relayed connections with the plurality of clients if the attempt to establish direct or client-relayed connections with the plurality of clients is successfully.

### CROSS-REFERENCE TO RELATED APPLICATIONS

This application is a continuation of International Patent Application No. PCT/CN2012/070304, filed on Jan. 13, 2012. This application claims the benefit and priority of Chinese Patent Application No. 201110047721.4, filed on Feb. 28, 2011 and entitled “Method and Apparatus for Establishing Audio and Video Communication Connection.” The entire disclosures of each of the above applications are incorporated herein by reference.

### TECHNOLOGICAL FIELD

The present invention relates to network technologies, particularly a method and apparatus for establishing audio and video communication connections.

### BACKGROUND OF THE INVENTION

With the advancement in network technologies, real-time audio and video communications between users is becoming more and more common. In existing real-time audio and video communication systems, for cost reasons, the data communication channel is often established using point-to-point or client-relayed connections. For example, in establishing a communication channel under the Interactive Connectivity Establishment (ICE) protocol, various connections, including direct connection, Session Traversal Utilities for NAT (STUN) connection and Traversal Using Relay NAT (TURN) connections, are attempted and evaluated; and the final connection between the two users is selected based on the quality of the connection and the time it takes to establish that connection.

In existing audio and video communication systems, it takes a period of time to select the appropriate connections to establish the audio and video communication; after a user sends an invitation for audio and video communication, the user must wait a period of time before the audio and video communication can be finally established. The lengthy process of establishing the connection adversely affects the user experience, and increases the operation costs.

### SUMMARY OF THE INVENTION

A method and apparatus for establishing an audio and video communication connection is provided in accordance with the embodiments of the present invention.

The method comprises the steps of establishing server-relayed connections with a plurality of clients; attempting to establish direct or client-relayed connections with the plurality of clients; and if the attempt to establish direct or client-relayed connections with the plurality of clients is successfully, disconnecting the server-relayed connections with the plurality of clients.

The apparatus comprises a first building module for establishing server-relayed connections with a plurality of clients, a second building module for attempting to establish direct or client-relayed connections with the plurality of clients; wherein the first building module is configured to disconnect the server-relayed connections with the plurality of clients if the attempt to establish direct or client-relayed connections with the plurality of clients is successfully.

In accordance with embodiments of the present invention, in establishing an audio and video communication connection in a multiplayer heterogeneous network environment, server-relayed connections with other clients are established first, which ensures that the audio and video communication connection among multiple users can be reliably and quickly established; other connections are attempted afterwards, and the server-relayed connections are disconnected when the other connections are successfully established, which reduces the operating costs of the multiplayer audio and video communication connection.

### BRIEF DESCRIPTION OF THE DRAWINGS

To better illustrate the technical features of the embodiments of the present invention or the prior art, various embodiments of the present invention and the prior art will be briefly described in conjunction with the accompanying drawings. It is obvious that the draws are but for exemplary embodiments of the present invention, and that a person of ordinary skill in the art may derive additional draws without deviating from the principles of the present invention.

FIG. 1 is an exemplary flowchart for a method of establishing an audio and video communication connection in accordance with an embodiment of the present invention.

FIG. 2 is another exemplary flowchart for a method of establishing an audio and video communication connection in accordance with an embodiment of the present invention.

FIG. 3 is an exemplary schematic diagram for an apparatus for establishing an audio and video communication connection in accordance with an embodiment of the present invention.

FIG. 4 is another exemplary schematic diagram for an apparatus for establishing an audio and video communication connection in accordance with an embodiment of the present invention.

FIG. 5 is yet another exemplary schematic diagram for an apparatus for establishing an audio and video communication connection in accordance with an embodiment of the present invention.

### DETAILED DESCRIPTION OF THE DRAWINGS

To better illustrate the technical features and the advantages of the present invention, various embodiments of the present invention will be further described in detail in conjunction with the accompanying drawings.

### Embodiment 1

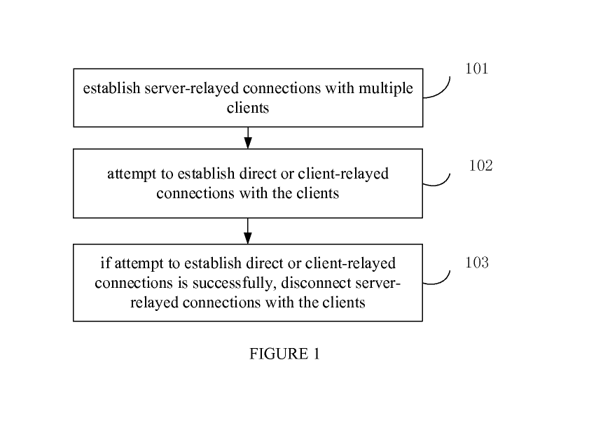

To reduce the connection time and operating costs for establishing a multiplayer audio and video communication connection in a complex network, a method for establishing an audio and video communication connection is provided in accordance with an embodiment of the present invention as shown in FIG. 1. The method includes the following steps:

Step 101: establish server-relayed connections with multiple clients;

Step 102: attempt to establish direct and/or client-relayed connections with the clients;

Step 103: if the attempt to establish direct or client-relayed connection is successful, disconnect the server-relayed connections with the clients.

The step of establishing server-relayed connections comprises the following: when any one of the multiple clients' initiates or establishes an audio and video connection, measure the network status of that client; if the network status of that client meets a first preset criterion, establish a server-relayed connection for that client.

The first preset criterion is designed to ensure that the server-relayed connection can be established quickly and stably, and may be set based on the experience of the technical staff or the minimum network speed required for server-relayed connections, and is not set a particular value in this embodiment of the present invention. It should be noted that, for some clients, the distance from the server, the communication time, et al, can all be a factor in setting the first preset criterion. For example, if client A is far away from client B, and there are many relay points between them, it might not be suitable to establish a direct or client-relayed connection between them, and that a server-relayed connection might be more appropriate.

Moreover, the method further includes the step of, if the attempt to establish direct or client-relayed connections is not successfully, maintaining the server-relayed connections.

Moreover, the method further includes the step of, if the attempt to establish direct or client-relayed connections is successfully, measuring the current audio and video communication connection, and switching to an alternative connection if any connection within the current audio and video communication connection does not meet a second preset criterion.

The step of measuring the current audio and video communication connection comprises collecting quality parameters of the current audio and video communication connection in real time, wherein the quality parameters include connection delay, packet loss and jitter; and evaluating the current audio and video communication connection based on the quality parameters and the second preset criterion.

It should be noted that the second preset criterion in this embodiment is the same as the third preset criterion in Embodiment 2 to be discussed below.

For example, connection quality may be expressed using the equation Q=w2*Delta+w2*Loss+w3*Jetter, wherein Q is the quality of the connection, Delta is the connection delay parameter, Loss is the packet loss parameter, and Jetter is the jitter parameter. If the value of Q tends to increase in a low-pass filter calculation, or reaches a certain threshold, then it shows that the quality of the connection is poor, and does not meet the second preset criterion. In this equation, w1, w2, and w3 are all externally adjustable parameters, and can be easily set based on external conditions to specify the requirement for connection quality. The second preset criterion is based on the transmission need.

In establishing an audio and video communication connection in a multiplayer heterogeneous network environment, server-relayed connections with other clients are established first, which ensures that the audio and video communication connection among multiple users can be reliably and quickly established; other connections are attempted afterwards, and the server-relayed connections are disconnected when the other connections are successfully established, which reduces the operating costs of the multiplayer audio and video communication connection.

### Embodiment 2

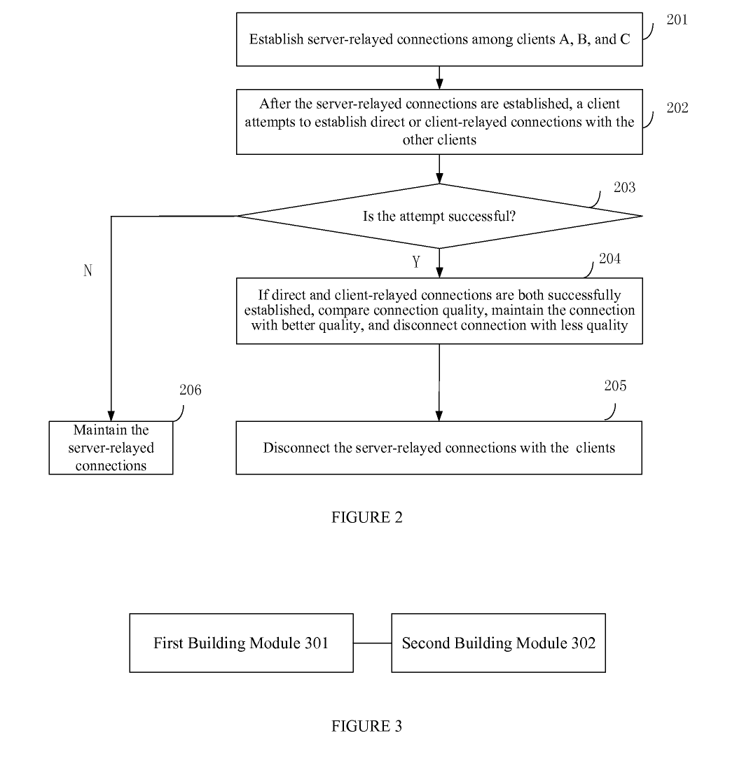

To reduce the connection time and operating costs for establishing a multiplayer audio and video communication connection in a complex network, a method for establishing an audio and video communication connection is provided in accordance with an embodiment of the present invention as shown in FIG. 2. The method will be illustrated using establishing multiplayer audio and video connections among clients A, B and C as an example, and includes the following steps:

Step 201: establish server-relayed connections among clients A, B, and C.

In this embodiment, a server-relayed connection is a connection in which a client first uploads data to a server, and then the server forwards the data to other clients. A multiplayer audio and video communication connection can be initiated by any one of the clients A, B, and C. When the server receives a request for establishing a multiplayer audio and video communication connection, it establishes server-relayed connections for clients A, B, and C on priority, which ensures that a data communication connection among the clients can be established quickly and reliably.

More specifically, Step 201 can also comprises the following steps: when any one of the multiple clients initiates an audio and video connection, measure the network status of that client; if the network status of that client meets a first preset criterion, establish a server-relayed connection for that client; otherwise, if the network status of that client does not meet the first preset criterion, establish a direct or client-relayed connection for that client. The first preset criterion is designed to ensure that the server-relayed connection can be established quickly and stably, and may be set based on the experience of the technical staff or the minimum network speed required for server-relayed connection. The first preset criterion is not limited to any particular number in accordance with this embodiment of the present invention. It should be noted that, for some clients, the distance from the server, the communication time, et al, can all become a factor in setting the first preset criterion. For example, if client A is far away from client B, and there are many relay points between them, it might not be suitable to establish a direct or client-relayed connection between them, and that a server-relayed connection might be more appropriate.

For example, the first preset criterion might be that the network speed for the client needs to reach 50k. When client A initiates an audio and video connection, the network speed of client A will be measured. If the network speed of client A is 100k, then a server-relayed connection will be established for client A. If the network speed of client A is 30k, then a direct or client-relayed connection will be established for client A.

Step 202: after server-relayed connections are established, client A attempts to establish direct and/or client-relayed connections with the other clients.

Preferably, any of the clients can attempt to establish audio and video connections. When multiple clients attempt to establish direction connections at the same time, each client needs to determine whether the connection is successful. When a client-relayed connection is attempted, the client also needs to determine whether the connection is successful.

In this embodiment, a direct connection is a connection in which data from a client does not goes through a server or another client, but reaches the receiving client (or the other client) directly through the transmission route.

In this embodiment, a client-relayed connection is a connection in which the data from a client first uploads to a third client, and the third client then forwards the data to the receiving client (or the other client).

In this embodiment, client A initiates the connection, then client A attempts to establish direct or client-relayed connections. In a variation of this embodiment, client A initiates the connection, then client B attempts to establish direct or client-relayed connections. The client imitating and establishing the connections can be any one of the multiple clients.

It should be noted that when the number of the clients exceeds a threshold value, server-relayed connections should be given priority to ensure the quality of the connections as the server has bigger capability for relaying connections.

Step 203: determine whether the attempts to establish direct and client-relayed connections are both successful, and if so, proceed to step 204; otherwise, proceed to step 206.

In this embodiment, after server-relayed connections are established, direct or client-relayed connections are attempted. If a direct connection is successfully established, then switch to the direct connection, and use the direct connection for audio and video communications between the clients. If a direct connection is not successfully established, determine whether a client-relayed connection is successfully established, and if so, switch to the client-relayed connection, and use the client-relayed connection for audio and video communications between the clients. If the client-relayed connection is also not successfully established, then maintain the server-relayed connection, and use the server-relayed connection for audio and video communications between the clients.

It should be noted that, the order of determining whether client-relayed or direct connections are successfully established can be modified so that whether client-relayed connection is successfully established is determined first, and then, if the client-relayed connection is not successfully established, whether direct connection is successfully connected is determined next. The determining order can be preset by the server based on the performance of the system, which will not be described in detail here.

Step 204: if both the direct and client-relayed connections are successfully established, compare the quality of the direct and client-relayed connections, and select the connection with better quality, and disconnect the connection with less quality.

In this embodiment, the comparison of connection quality can be performed by collecting quality parameters of the audio and video communication connection, calculating the connection quality using preset methods, and obtaining the comparison results.

For example, if the quality of direct connection is better than the client-relayed connection in this embodiment, then disconnect the client-relayed connection in step 204.

Step 205: disconnect the server-relayed connections with the clients.

Furthermore, if the direct connection and client-relayed connection are successfully established, this step further includes the step of measuring the current audio and video communication connection, and switching to an alternative connection if any connection within the current audio and video communication connection does not meet a third preset criterion.

In this step, if the quality of the direct connection is not stable, or the direct connection is disconnected for some reasons, switch to another connection, such as client-relayed or server-relayed connection.

The step of measuring the current audio and video communication connection further includes steps S1 and S2.

Step S1: collecting quality parameters of the current audio and video communication connection in real time, wherein the quality parameters include connection delay, packet loss and jitter; and may include other quality parameters not specified in this embodiment here.

Step S2: evaluating the current audio and video communication connection based on the quality parameters and a third preset criterion.

In Step S2, it may be necessary to process the quality parameters, such as obtaining a weighted sum.

For example, connection quality may be expressed using the equation Q=w2*Delta+w2*Loss+w3*Jetter, wherein Q is the quality of the connection, Delta is the connection delay parameter, Loss is the packet loss parameter, and Jetter is the jitter parameter. If the value of Q tends to increase in a low-pass filter calculation, or reaches a certain threshold, then it shows that the quality of the connection is poor, and does not meet the second preset criterion. In this equation, w1, w2, and w3 are all externally adjustable parameters, and can be easily set based on external conditions to specify the requirement for connection quality. The third preset criterion is based on the transmission need.

It should be further noted that the detailed mechanics for establishing server-relayed connection, direct connection, and client-relayed connections in accordance with the present inventions are well known to those skilled in the art, and will not be described in detailed here.

Step 206: maintain the server-relayed connections.

In establishing an audio and video communication connection in a multiplayer heterogeneous network environment, server-relayed connections with other clients are established first, which ensures that the audio and video communication connection among multiple users can be reliably and quickly established; other connections are attempted afterwards, and the server-relayed connections are disconnected when the other connections are successfully established, which reduces the operating costs of the multiplayer audio and video communication connection.

### Embodiment 3

An apparatus for establishing an audio and video communication connection is also provided in accordance with one embodiment of the present invention. FIG. 3 is an exemplary schematic diagram for an apparatus for establishing an audio and video communication connection in accordance with an embodiment of the present invention. As shown in FIG. 3, the apparatus includes a first building module 301, for establishing server-relayed connections with multiple clients; and a second building module 302, for attempting to establish direct or client-relayed connections with the clients.

The first building module 301 can be used to disconnect the server-relayed connections with the clients if the attempt to establish direct or client-relayed connections is successfully.

The first building module 301 can be used to measure the network status of a client attempting to initiate or establish audio and video communication connection, and establish an audio and video communication connection with the client when the network status of the client meets a first preset criterion.

The first building module 301 can also be used to maintain the server-relayed connections if the attempt to establish direct or client-relayed connections is not successfully.

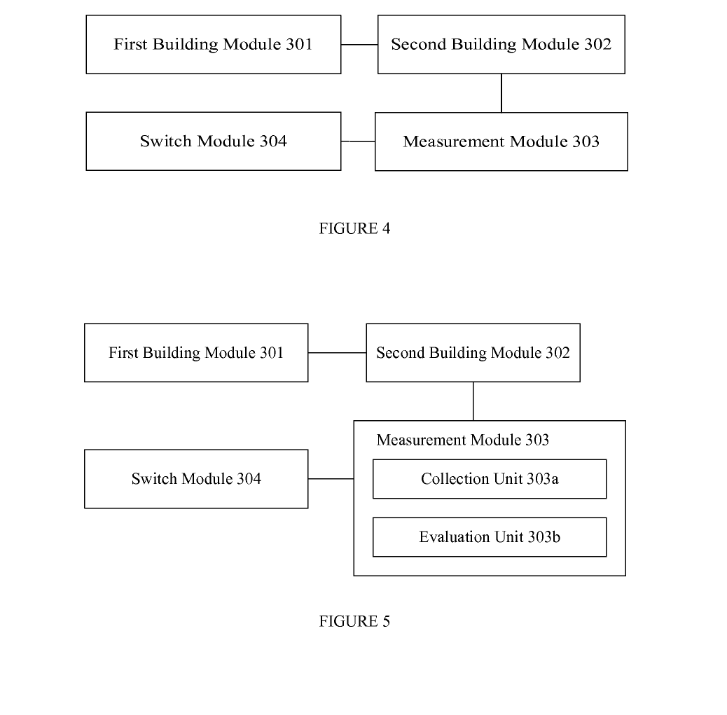

FIG. 4 is another exemplary schematic diagram for an apparatus for establishing an audio and video communication connection in accordance with an embodiment of the present invention. As shown in FIG. 4, the apparatus includes a measurement module 303 used to measure the current audio and video communication connection if the attempt to establish direct or client-relayed connections with the plurality of clients is successfully, and a switch module 304 used to switch to an alternative connection if any connection within the current audio and video communication connection does not meet a second preset criterion.

FIG. 5 is yet another exemplary schematic diagram for an apparatus for establishing an audio and video communication connection in accordance with an embodiment of the present invention. As shown in FIG. 5, the measurement module 303 includes a parameter collection unit 303a, for collecting quality parameters of the audio and video communication connection in real time, including connection delay, packet loss and jitter; and an evaluation unit 303b, for evaluating the audio and video communication connection based on the quality parameters and the second preset criterion.

The first preset criterion is at least partially based on the minimum network speed required for server-relayed connection, the distance between the server and the client, or the communication time.

The second preset criterion is based on the transmission need.

The apparatus in accordance to this embodiment can implemented as a server, whose operation principle is the same as the methods provided in accordance with embodiments of the present invention, and will not be described in detail here.

The technical features provided by the embodiments of the present invention can be implemented in whole or in part by hardware and/or software, wherein the software can be stored in readable storage media, such as ROM, RAM, magnetic disk, CDs, or other suitable media for storing program codes.

The above detailed descriptions are but for several specific embodiments of the present invention, and are not intended to limit the scope of the present invention. Any modification or improvement made by person of ordinary skill in the art without deviating from the principles of the present invention is still within the scope of the present invention, which is defined solely by the appended claims.

What is claimed are:

1. A method for establishing an audio and video communication connection, comprising the steps of:
establishing server-relayed connections with a plurality of clients;
attempting to establish direct or client-relayed connections with the plurality of clients; and
if the attempt to establish direct or client-relayed connections with the plurality of clients is successfully, disconnecting the server-relayed connections with the plurality of clients.

2. The method of claim 1, wherein the step of establishing server-relayed connections with a plurality of clients further comprises measuring a network status of a client, and establishing an audio and video communication connection with the client when the network status of the client meets a first preset criterion.

3. The method of claim 2, wherein the first preset criterion is at least partially based on a minimum network speed required for server-relayed connection, a distance between the server and the client, or a communication time.

4. The method of claim 1, further comprises, if the attempt to establish direct or client-relayed connections with the plurality of clients is not successful, maintaining the server-relayed connections with the plurality of clients.

5. The method of claim 1, further comprises, if the attempt to establish direct or client-relayed connections with the plurality of clients is successful, measuring the current audio and video communication connection, and switching to an alternative connection if any connection within the current audio and video communication connection does not meet a second preset criterion.

6. The method of claim 5, wherein the step of measuring the current audio and video communication connection further comprises collecting quality parameters of the current audio and video communication connection in real time; and evaluating the current audio and video communication connection based on the quality parameters and the second preset criterion;
wherein the quality parameters comprise connection delay, packet loss and jitter.

7. The method of claim 6, wherein the second preset criterion is based on transmission need.

8. An apparatus for establishing an audio and video communication connection, comprising:
a first building module for establishing server-relayed connections with a plurality of clients;
a second building module for attempting to establish direct or client-relayed connections with the plurality of clients;
wherein the first building module is configured to disconnected the server-relayed connections with the plurality of clients if the attempt to establish direct or client-relayed connections with the plurality of clients is successfully.

9. The apparatus of claim 8, wherein the first building module is configured to measure a network status of a client attempting to establishing an audio and video communication connection, and establish a server-relayed connection with the client when the network status of the client meets a first preset criterion.

10. The apparatus of claim 9, wherein the first preset criterion is at least partially based on a minimum network speed required for server-relayed connection, a distance between the server and the client, or a communication time.

11. The apparatus of claim 8, wherein the first building module is configured to maintain the server-relayed connections with the plurality of clients if the attempt to establish direct or client-relayed connections with the plurality of clients is not successfully.

12. The apparatus of claim 8, further comprises a measurement module configured to measure the current audio and video communication connection if the attempt to establish direct or client-relayed connections with the plurality of clients is successfully, and a switch module configured to switch to an alternative connection if any connection within the current audio and video communication connection does not meet a second preset criterion.

13. The apparatus of claim 12, wherein the measurement module comprises
a parameter collection unit for collecting quality parameters of the audio and video communication connection in real time; and
an evaluation unit for evaluating the audio and video communication connection based on the quality parameters and the second preset criterion,
wherein the quality parameters comprise connection delay, packet loss and jitter.

14. The apparatus of claim 12, wherein the second preset criterion is based on the transmission need.
